(19) United States
(12) Patent Application Publication
(10) Pub. No.: US 2023/0147445 A1
(43) Pub. Date: May 11, 2023

(54) METHOD OF INDUCING IMPLEMENTATION OF DRIFT DRIVING UTILIZING LIQUID SPRAYER

(71) Applicant: Jose Juan Islas, Redwood City, CA (US)

(72) Inventor: Jose Juan Islas, Redwood City, CA (US)

(21) Appl. No.: 17/523,471

(22) Filed: Nov. 10, 2021

(51) Int. Cl. B60B 39/02

(52) U.S. Cl. CPC B60B 39/025; B60B 39/022; B60W 30/02; B60W 2520/20

(57) ABSTRACT

A liquid sprayer control method to induce drift driving for a vehicle, wherein the control apparatus includes a liquid sprayer attached to a tank of fluid, which in turn has two small hoses aiming towards the rear tires of a vehicle. With a simple push-button controller at the driver’s command, the driver sprays liquid onto the rear tires, coating them for an effective loss of traction of the rear tires, allowing the driver to induce a drift, or intentional loss of rear traction of the vehicle for closed-course exhibition or educational purposes.

### BACKGROUND OF THE INVENTION

The present invention relates generally to a method of controlling implementation of a driving state of a vehicle and, more precisely, to a method of controlling a vehicle that is in effect, driven into a state of drift where the vehicle’s driver intentionally oversteers the vehicle, causing the rear wheels to slip and loose grip, essentially going into a skid that is controlled by the driver through a high degree of skillful maneuvers. In order to maintain this state of drift, the driver has to sharply change a steering position while adjusting torque via the gas pedal, and by selectively engaging the manual parking brake to maintain the drift and angle of the vehicle as the driver desires. This type of driving is incredibly strenuous on a vehicle that may not be adequately equipped with proper suspension and tire setups, both of which can be prohibitively expensive, as well as requiring a driver with very high skill. However, it may be desirable to allow a driver of lesser skill in a vehicle that is not as heavily upgraded to enter a vehicle into a drift with less effort, less wear and tear, less waste of tires, for the purposes of teaching or for closed course exhibitions such as drift competitions.

The inventor herein has recognized the above-mentioned issues and has developed a vehicle operating method, comprising: an on-demand vehicle drift enabler via a simple button controller that, connected to a liquid sprayer attached to a plastic liquid tank and two plastic 5/16″ rubber hoses, sprays water-based lubricant directly onto the rear tires, coating them with a soluble lubricant so that the driver may induce the vehicle into a drift condition. The lubricant solution induces tire spin immediately and with little effort in part from the engine as less torque is required to lose tire traction; reducing the need for high horsepower requirements, reduces stress on the driveline components (transmission, driveshaft, differential) as well as reducing wear on the brakes and tires. In addition, a driver does not have to possess a high level of skill in order to enable the rear of the car to begin to drift as it can be achieved with significantly less speed, making teaching how to handle skids easier and with less expense and risk to the driver and vehicle. In addition, most high-performance rear-wheel drive (FR) vehicles intended for drifting require the need for a Limited Slip Differential (LSD) which functions by distributing torque between left and right wheels according to a driving situation. LSD differentials are typically more expensive than what is found standard on most vehicles which normally come equipped with non-LSD differentials, meaning only one wheel drives the torque and the other wheel is there for the ride, making drifting almost impossible as in order to efficiently go into a state of drift both tires should be receiving the torque to lose traction.

### BRIEF DESCRIPTION OF THE DRAWINGS

FIG. 1 shows a typical Front Engine, Rear Wheel Drive (FR) vehicle setup, clearly showing the layout of the driveline; the transmission, driveshaft, and rear differential that drives the power to the rear wheel(s).

FIG. 2 is a basic visual depiction of a Vehicle entering into a Drift State, or skidding of the rear wheels, while the driver countersteers for a desired angle through torque and slip.

FIG. 3 is a Vehicle Diagram with the Proposed Invention installed on a Front engine, Rear wheel drive vehicle (FR). The invention is clearly shown with all components and connections needed for the system to function correctly.

### DETAILED DESCRIPTION

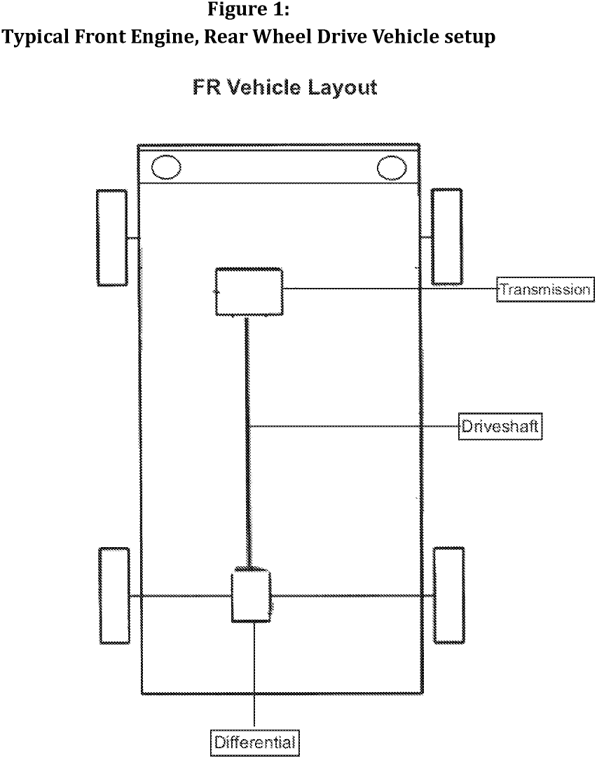

The following description relates to systems and methods for operating a driveline or powertrain of a Front engine, Rear wheel drive (FR) vehicle. FIG. 1 shows an example of the typical layout of a FR vehicle that includes driveline, transmission, driveshaft and rear differential. When slipping, or the skidding of the rear wheels occurs via the output of the torque of the transmission through driver input, much effort has to be applied in order for a vehicle to go into a drift. A method of controlling implementation of a drift driving state of a vehicle according to an exemplary embodiment of the present invention is applied to the vehicle as above, so drifting of the vehicle is possible whenever the driver desires. The system, collectively, is designed to work best in a vehicle with a front-engine, rear-wheel drive (FR) setup though it can work in other applications such as on vehicles with front-engine, front-wheel drive (FF) or even on vehicles equipped with all-wheel drive (AWD) setups and the system can yield similar results. For the purposes of the diagrams and for simplicity’s sake, we’ll refer to this invention for what it was intended to work best on; the front-engine, rear-wheel drive (FR) setup as it is the most common platform for police and other emergency vehicles as well as racing vehicles for the sport of drifting or other closed-course exhibitions.

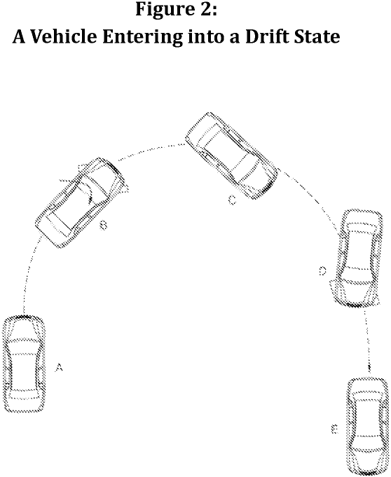

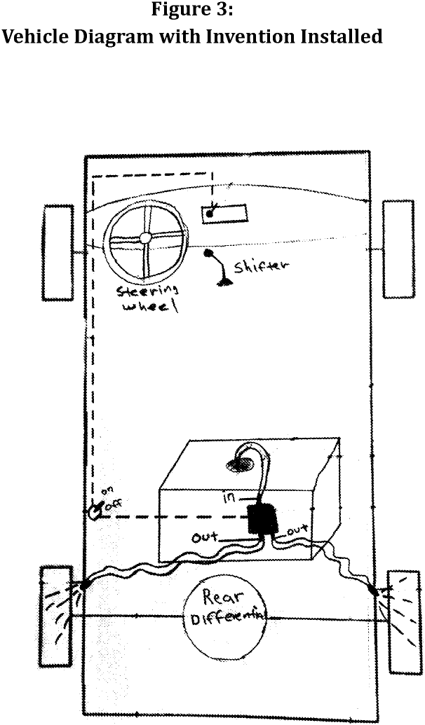

The system works in detail by (FIG. 3);
1. The installed button controller 1 connected to an electric wire 2 to a safety kill switch 3 located in the trunk or rear of the vehicle to prevent accidental use of the system, which in turn when activated, at will, turns on a small electric liquid sprayer 4 that is connected to a fluid liquid tank 5 with an inlet rubber hose 6 that is located in the trunk or rear of the vehicle which is also connected to two plastic hoses 8 that are installed on top of the two rear tires with sprayer nozzles 7 at the tips to evenly and efficiently coat the rear tires on demand.
2. When the driver desires to enter into a drift, the driver sprays the rear tires by holding down the button for as long as the driver desires, usually a few seconds, until the rear tires are ‘primed’ for the driver’s maneuvers.
3. The driver, once having coated the rear tires, will enter into a drift state by slip torque by accelerating and counter steering, in which the driver operates a steering wheel opposite direction to rotation, maintaining the drift via the momentum of the weight of the vehicle until the driver reduces the speed of the car via deceleration as shown in FIG. 2.

What is claimed is:

1. A method of controlling implementation of a drift driving state of a vehicle, the method comprising: inducing, by a spray controller, the rear wheels to lose traction when the driver decides to go into a drift, the vehicle’s rear tires are coated with lubricant solution in order for the vehicle to enter into a rotary driving, or drift; allowing, by the spray controller, the vehicle enters into drift driving state for as long as the driver can maintain it using the spray controller.

2. The method of claim 1, wherein the slip control torque determined to be decreased as the lateral acceleration of the vehicle increases.

3. The method of claim 1, wherein the slip of the rear tires is activated through the driver’s control, can and will be maintained as long as the sprayer continues to spray lubricant onto rear tires or until driver releases controller and torque, whereby, the vehicle will seize to remain in drift state.
